(19) United States
(12) Patent Application Publication
(10) Pub. No.: US 2008/0133190 A1
(43) Pub. Date: Jun. 5, 2008

(54) METHOD AND A SYSTEM FOR PLANNING A SECURITY ARRAY OF SENSOR UNITS

(76) Inventors: Shay Peretz, Shimshit (IL); Yorai Gabriel, Tel Aviv (IL); Dror Ouzana, Haifa (IL); Ittai Bar-Joseph, Shimshit (IL); Eran Shefi, Jerusalem (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/740,008

(22) Filed: Apr. 25, 2007

Related U.S. Application Data
(63) Continuation-in-part of application No. 11/278,860, filed on Apr. 6, 2006.
(60) Provisional application No. 60/772,557, filed on Feb. 13, 2006.

(51) Int. Cl. G06G 7/48

(52) U.S. Cl. 703/6

(57) ABSTRACT

The present invention discloses a computerized method for providing a user with at least one scenario in a modeled theater. The computerized method may include the following steps: a) selecting a plurality of threat-sites in the modeled theater, wherein the threat-site comprises at least one of the following: at least one threat-area, and at least one threat object; b) selecting at least one allowed-site in the modeled theater, wherein the allowed-site is at least one of the following: at least one allowed-area, and at least one allowed-object; c) providing at least one constraint parameter; and d) determining the at least one security scenario. The security scenario may pertain to at least one of the following: the position of at least one sensor in the at least one allowed-site. Determining of the at least one scenario may be accomplished according to computational analysis of at least one of the following: geographical information data, gathered data, and user input data. The computational analysis may include the testing of the effect of the at least one constraint parameter on the monitoring capabilities of the at least one threat-site by the at least one sensor.

### CROSS-REFERENCE TO RELATED APPLICATIONS

This is a continuation-in-part of U.S. Patent Application No. 60/772,557 filed Feb. 13, 2006.

### FIELD OF INVENTION

The present invention relates to the field of surveillance planning systems and methods. More specifically, the present invention relates to the field of a sensor location planning system and method.

### BACKGROUND OF INVENTION

Various operations are becoming increasingly dependent on intelligent systems to guide the designing of security architectures and planning of mission tasks. The demand for comprehensive security solutions involving advanced technology is rapidly increasing, thereby constituting the need for a robust decision support computer-based framework.

Security operations may be extensively varied by nature, threats or cost. Some operations demand the planning of multiple routes for mobile dynamic force-tasks, while others require the planning of architecture for securing facilities and surveillance.

U.S. Pat. No. 6,687,606, which is incorporated by reference herein, discloses a method that analyzes a plan for scanning the content of a predetermined area. The method includes the steps of: providing a plan for at least one entity, the plan including a route and a set of scan points; and assigning an associated score for the plan in order to compare the plan to other plans, the score indicating the quality of the plan.

U.S. Pat. No. 6,718,261, which incorporated by reference herein, discloses a method for routing a plurality of entities through a predetermined area. The method includes the steps of: providing a plan; providing a deterministic method for computing the plan for the plurality of entities, the plan including a plurality of routes and sets of scan points for each of the entities; and performing the method by each of the plurality of entities independently from the other of the plurality of entities.

### SUMMARY OF SOME EMBODIMENTS OF THE INVENTION

The present invention discloses a computerized method and system that supports sensor array planning

In embodiments of the invention, the computerized method and system provides a user with at least one scenario in a modeled theater.

In embodiments of the invention, the computerized method includes the step of selecting a plurality of threat-sites in the modeled theater, wherein the threat-site comprises at least one of the following: at least one threat-area, and at least one threat object.

In embodiments of the invention, the computerized method includes the step of selecting at least one allowed-site in the modeled theater, wherein the allowed-site is at least one of the following: at least one allowed-area, and at least one allowed-object.

In embodiments of the invention, the computerized method includes the step of providing at least one constraint parameter.

In embodiments of the invention, the computerized method includes the step of determining the at least one security scenario, the security scenario pertaining to at least one of the following: the position of at least one sensor in the at least one allowed-site.

In embodiments of the invention, the determining the at least one scenario is accomplished based on computational analysis of at least one of the following: geographical information data, gathered data, and user input data.

In embodiments of the invention, the computational analysis includes the testing of the effect of the at least one constraint parameter on the monitoring capabilities of the at least one threat-site by the at least one sensor.

In embodiments of the invention, the at least one sensor position provides optimized coverage of the plurality of threat-site.

In embodiments of the invention, the computerized method comprises the step of schematically illustrating the at least one scenario on an output unit.

In embodiments of the invention, the at least one of the scenarios provides optimized coverage of the plurality of threat-sites out of all possible scenarios that are determinable by taking into account the at least one constraint parameter.

In embodiments of the invention, a plurality of scenarios is presented to the user in an order that corresponds to the threat-site coverage provided by the at least one sensor.

In embodiments of the invention, the at least one constraint parameter further indicates at least one of the following: sensor type; operational parameters of the sensor; sensor availability; visibility of the threat-site depending on environmental conditions; budgetary constraints; communication network parameters; a weighing factor indicating the importance of each threat-site with regard to surveillance requirements, the importance of at least one sector within the at least one threat-site with regard to surveillance requirements; and minimal overlying area covered by two sensors.

In embodiments of the invention, the computational analysis comprises at least one of the following: image analysis and geometrical analysis. In embodiments of the invention the at least two distinct weighing factors are assigned to at least two corresponding parameter constraints for determining the order according to which the at least two parameter constraints are to be taken into consideration for determining the at least one constraint.

In embodiments of the invention, a threat area is defined by simulating the progression of a real object along at least one path in the real terrain within a certain time interval “t”, by means of a virtual object in the modeled theater.

In embodiments of the invention, the at least one scenario is selectably viewable from various angles in a successive and simultaneous manner.

In embodiments of the invention, the computerized method comprises the step of estimating attenuation of a communication signal between the at least one sensor and a receiver of the signal.

In embodiments of the invention, the computerized method comprises the step of schematically displaying the attenuation.

In embodiments of the invention, the computerized method comprises the step of recording a frame of the at least one scenario and schematically displaying the at least one frame.

In embodiments of the invention, the computerized method comprises the step of issuing a report comprising data about the at least one scenario.

In embodiments of the invention, the report is issued in at least one of the following formats: an HTML file format, a spreadsheet formal, and an image format.

Furthermore, the present invention discloses a computer-aided security design system that enables providing a user with at least one scenario in a modeled theater.

In embodiments of the invention, the system comprises a computing module adapted to select a plurality of threat-sites in the modeled theater, wherein the threat-site comprises at least one of the following: at least one threat-area, and at least one threat object.

In embodiments of the invention, the computing module is adapted to select at least one allowed-site in the modeled theater, wherein the allowed-site is at least one of the following: at least one allowed-area, and at least one allowed-object.

In embodiments of the invention, the computing module is adapted to provide at least one constraint parameter

In embodiments of the invention, the computing module is adapted to determine the at least one security scenario, the security scenario pertaining to at least one of the following: the position of at least one sensor in the at least one allowed-site.

### BRIEF DESCRIPTION OF THE DRAWINGS

These and further features and advantages of the invention will become more clearly understood in the light of the ensuing description of a some embodiments thereof, given by way of example only, with reference to the accompanying figures, wherein:

FIG. 1 is a schematic block diagram illustration of the data flow in a computer-aided security design system, according to some embodiments of the invention;

FIG. 2 is a flow chart of a simple planning method implemented by the computer-aided security design system of FIG. 1, according to some embodiments of the invention;

FIG. 3 is a flow chart of another embodiment of the simple planning method implemented by the computer-aided security design system of FIG. 1;

FIG. 4 is a flow chart of an advanced planning method implemented by the computer-aided security design system of FIG. 1, according to some embodiments of the invention;

FIG. 5 is a schematic illustration of a model of a real theater and the position of at least one sensor therein, according to some embodiments of the invention;

FIG. 6 is a schematic illustration of a model of another theater, and the coverage area for corresponding sensors positioned therein, according to some embodiments of the invention;

FIG. 7 is another illustration of the modeled theater of FIG. 6 having sensors positioned therein, and the area of coverage of the sensors, according to some embodiments of the invention;

FIG. 8 is a schematic block diagram illustration of a computer-aided security design system according to another embodiment of the invention;

FIG. 9 is a schematic illustration of a model of a yet another real theater, according to some embodiment of the invention;

FIG. 10 is a schematic illustration of the modeled theater of FIG. 9, wherein virtual allowed-sites are indicated, according to some embodiment of the invention;

FIG. 11 is a schematic illustration of the modeled theater of FIG. 9, wherein a plurality of virtual allowed-sites as well as a plurality of virtual threat-sites are indicated, according to an embodiment of the invention;

FIG. 12 is a schematic illustration of the areas of coverage of a first real threat-site provided by a first real sensor in a first position, by means of a first scenario modeled by the system of FIG. 8, according to some embodiments of the invention;

FIG. 13 is a schematic illustration of the areas of coverage within the first real threat site provided by a second and third real sensor in respective positions, by means of a second scenario modeled by the system of FIG. 8, according to some embodiments of the invention;

FIG. 14 is a schematic illustration of the areas of coverage provided by the first, second and third real sensor of the first threat site, by means of a third scenario modeled by the system of FIG. 8, according to some embodiments of the invention;

FIG. 15 is a schematic illustration of the area of coverage of the first real sensor in dependence from the visibility conditions that may prevail in the environment of the theater, by means of corresponding scenarios modeled by the system of FIG. 8, according to some embodiments of the invention;

FIG. 16A is a schematic illustration of the distance a object may pass from a starting point by means of the system of FIG. 8, wherein the distance may be a function of the real object's direction of movement as well as a function of time, according to some embodiments of the invention;

FIG. 16B is a schematic illustration of a first object and a second object and the corresponding distances each of the objects may traverse, as well as an area of overlap of the corresponding distances, according to some embodiments of the invention;

FIG. 17 is schematic illustration of an image of a sector of the real terrain modeled by the system of FIG. 8, according to some embodiments of the invention;

FIG. 18 is a schematic illustration of an altered image of the same sector modeled by the system of FIG. 8, according to some embodiments of the invention;

FIG. 19 is a schematic illustration of the attenuation of a real signal sent from a real sensor to a real antenna that are positioned in the theater, by means of a model generated by the system of FIG. 8; and

FIG. 20 is a flow-chart illustration of a computer-aided security design method that may be implemented by the system of FIG. 8, according to an embodiment of the invention.

The drawings taken with description make apparent to those skilled in the art how the invention may be embodied in practice.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate identical elements.

### DESCRIPTION OF SOME EMBODIMENTS OF THE INVENTION

According to some embodiments of the invention, a computer-aided security design system (hereinafter referred to as “CASD system”) and method enables determining a security scheme that may pertain to, for example, the position of one or more sensors in a theater and the resulting surveillance coverage of a threat-site by the sensor(s). According to some embodiments of the invention, a CASD system may determine the position of the sensor(s) that will provide optimal surveillance coverage of the threat-site.

According to some embodiments of the invention, the CASD system determines the position of the sensor(s) according to computational analysis of theater data (such as terrain data), allowed-site data, and threat-site data. The computational analysis includes the testing of the effect of at least one parameter constraint on the surveillance coverage of a threat-site by the sensor(s).

Correspondingly, the CASD system stores therein, inter alia, geographical information (GI) data of the theater (hereinafter referred to as “theater data”) and enables a user to provide the CASD system with inputs of design constraints such as, for example, coordinates of a threat-site such as a coordinates of a threat-area and threat-object; the coordinates of an allowed-site; visibility parameters that may depend on meteorological conditions; scanning parameters; sensors parameters such as, for example, tilt, yaw, pitch, zoom, dynamic range; communication network parameters and the like; mathematical distinctive weighing factors for different threat-sites and/or for sectors of the same threat-site, wherein each weighing factor corresponds to the relative importance pertaining to surveillance requirement.

According to some embodiments of the invention, the CASD system may display on a two-dimensional display a virtual three-dimensional (3D) model of a theater according to at least some of the GI data and may schematically display in the virtual theater a security scenario schematically illustrating, for example, a position of at least one sensor and the corresponding surveillance area covered by the sensor. According to some embodiments of the invention, the position of the at least one sensor may be optimized with regard to surveillance effectiveness such as, for example, percentage of coverage of a certain threat-site, time available for intercepting an intruder and the like.

Accordingly, the CASD system may be beneficial in establishing an effective defense and/or attacking plan and the like for any theater and/or site and/or area involved.

It should be understood that an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions.

It should be understood that the phraseology and terminology employed herein is not to be construed as limiting and is for descriptive purpose only.

The principles and uses of the teachings of the present invention may be better understood with reference to the accompanying description, figures and examples.

It should be understood that the details set forth herein do not construe a limitation to an application of the invention. Furthermore, it should be understood that the invention can be carried out or practiced in various ways and that the invention can be implemented in embodiments other than the ones outlined in the description below.

It should be understood that the terms “including”, “comprising”, “consisting” and grammatical variants thereof do not preclude the addition of one or more components, features, steps, integers or groups thereof and that the terms are not to be construed as specifying components, features, steps or integers.

The phrase “consisting essentially of”, and grammatical variants thereof, when used herein is not to be construed as excluding additional components, steps, features, integers or groups thereof but rather that the additional features, integers, steps, components or groups thereof do not materially alter the basic and characteristics of the claimed composition, device or method.

If the specification or claims refer to “an additional” element, that does not preclude there being more than one of the additional element.

It should be understood that where the claims or specification refer to “a” or “an” element, such reference is not to be construed as there being only one of that element.

It should be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The term “method” refers to manners, means, techniques and procedures for accomplishing a given task including, but is not limited to those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein ought to be commonly understood as by one of ordinary skill in the art to which the invention belongs, unless otherwise defined.

The present invention can be implemented in the testing or practice with methods and materials equivalent or similar to those described herein.

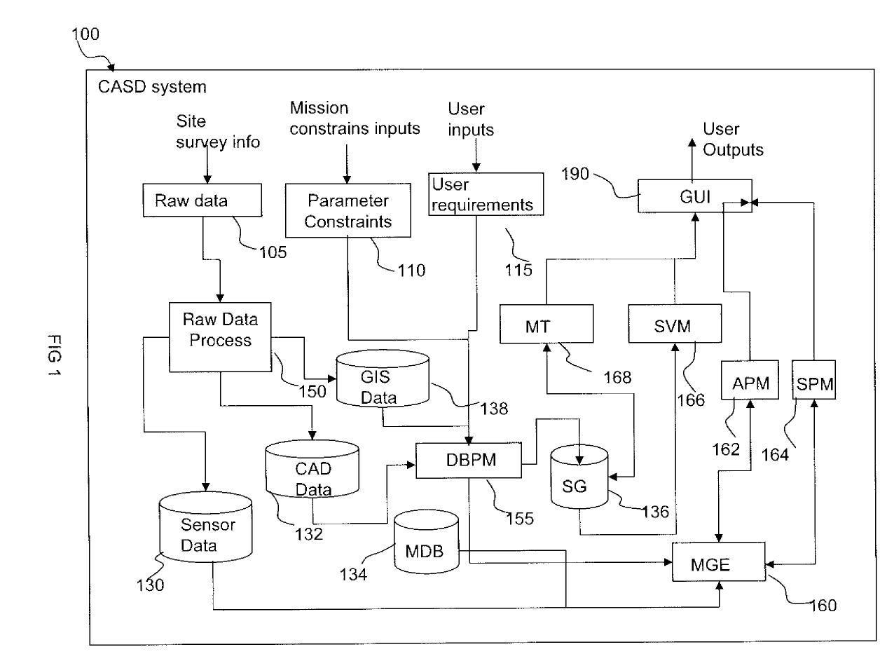

Reference is now made to FIG. 1. A CASD system 100 may receive raw data 105 that may represent of site survey info comprising GI data and/or construction data (CAD) and/or sensor data may be processed 150 and may be stored in relevant databases 138, 132 and 130, respectively. Survey GI data may represent, for example, surface elevation data, locations of objects (e.g., trees, rocks, buildings and the like). A Data Base Pre-process Module (DBPM) 155 may fetch data from the GI database 138, CAD database 132 and/or from the sensor database 130. The fetched data may then be stored in a Scene Graph (SG) database 136 that enables optimized graphical capabilities, which may be needed during automatic planning processes conducted by, e.g., an automatic planning module (APM) 162; and which may be needed by simple planning processes conducted by e.g., a simple planning module (SPM) 164. The APM 162 as well as the SPM 164 may utilize a mathematic geometric engine (MGE) 160 or any other suitable engine. MGE 160 enables the generation of geometric data by using algorithms that enable solving optimization tasks and decision problems derived from sensor position planning. The algorithms used by MGE 160 may use a mathematical database (MDB) 134, which, in turn, enables access to relevant data during calculation processes and analysis phases. A virtual 3D theater is modeled and displayed on the GUI device 190, which may be, for example, a liquid crystal computer monitor screen. Once all relevant raw data are processed, a Simulation Visualization Module (SVM) 166 may provide a graphic simulation of a specific scenario in the theater, the scenario being instantiated by mission constraints data 10 and specific user requirements 115.

Scenario simulation may be manipulable (i.e., scenario simulation may be modified and/or adapted and/or adjusted) by, e.g., a user via a suitable Modeling Tool (MT) 168. MT 168 enables the user, for example, to add, remove and modify objects displayed in the modeled theater. For example, the user may add and/or remove and/or alter the shape of, e.g., trees, rocks, buildings, barriers, fences, compounds, hills, and the like. The MGE 160 may be adapted to provide geometrical analysis of the site data for testing the design constraints effect on each sensor units monitoring capabilities.

As already mentioned hereinabove, the user can provide the CASD system 100 with inputs of various types of scenario alternatives, wherein the CASD system 100 generates in return at least one solution.

According to some embodiments of the invention, the CASD system 100 generates a visual representation 270 for each solution.

A plan module allows different types of simulation. In general, the plan module can be activated by SPM 164 and/or an APM 162. Based on specific coordinates and sensor data, the solution determined by the SPM 164 provides a simulation and optionally provides schematically a graphical representation of the solution that may include, for example, a coverage area by one or more sensors, latitude recommendations, angle recommendations (e.g., roll, pitch and yaw), viewpoints from each sensor, and the like. The APM module 162 may determine an optimized security solution based on user constraints specifications.

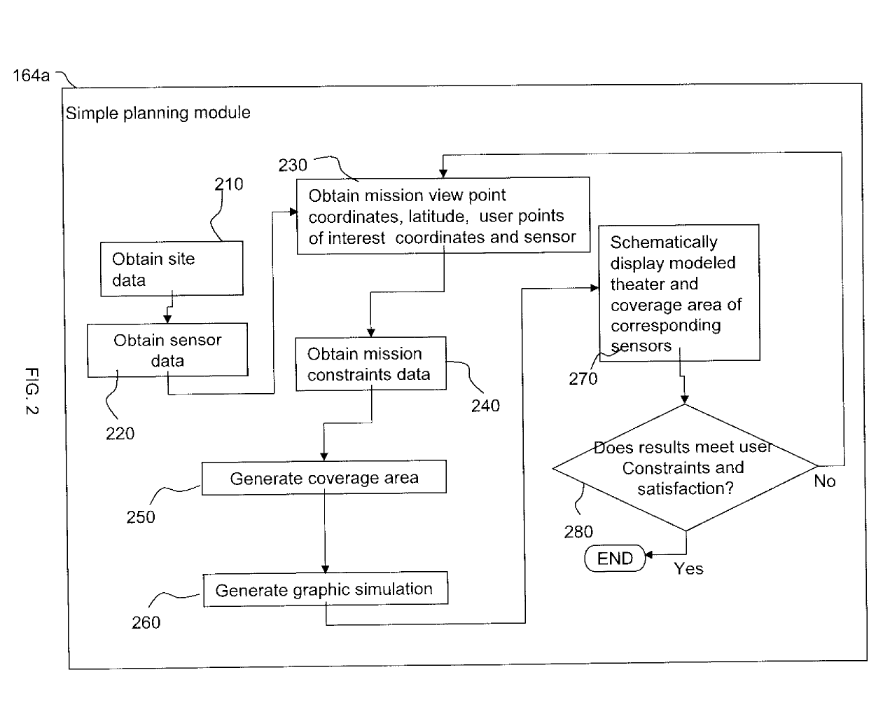

Reference is now made to FIG. 2. In an embodiment of the invention, an SPM 164a may execute a sensor planning method that may determine, for example, the optimal position of on or more sensors in a real theater and may display a map that schematically indicates the coverage area of the same sensor in the real theater, and the like. A method of determining the optimal position of the sensor(s) may include the step of obtaining GI data 210. The GI data 210 may represent, for example, information about entities in the real theater (e.g., shape and/or location of a house, a hill, a rock, a building and the like), and the graphical representation of the same terrain when the entity is virtually removed, such as in response to a suitable user input.

According to some embodiments of the invention, determining the optimal position of the sensor(s) may include the step of obtaining sensor data 220. Sensor data may represent functionality such as, for example, radar, image sensor, optical sensor, acoustic sensor, chemicals sensors, radiological sensors, biological sensors, Geiger counter sensors, thermal sensors and the like; cost of each sensor; availability; operational parameters such as, for example, pitch, roll, yaw, zoom range, dynamic range, operating temperatures, weighing factors, and the like.

According to some embodiments of the invention, sensor data may be stored in the CASD system 100 as a standard object-like table. Once the SPM 164a has fetched the GI data and the sensor from the database of the CASD system 100, the method may include, for example, obtaining from the user inputs pertaining to a specific scenario, as schematically indicated by box 230. The user input may represent, for example, a target area, target points of interest, a friendly area, sensor preferences and the like using, e.g., the SVM graphic simulator 166. The SVM graphic simulator 166 may provide the user to a schematic 3D graphical representation of the area, through a selection of available sensors and selection by the user of the exact point of view and points of interest needed for the scenario. The SVM simulator 166 may provide the user with a plurality of selections of view points. In an embodiment of the invention, the selections may be provided to the user either sequentially or simultaneously. According to some embodiments of the invention, data representing different sensor types may be associated to data representing different positions in the real theater.

According to some embodiments of the invention, the method of planning the position of at least one sensor in the theater may include, for example, obtaining design constraints that must be met for each scenario from the user, as schematically indicated by box 240. Such constraints may include, for example, minimum required coverage area (e.g., in percentage of coverage), maximum feasible latitude budgetary limitations, and the like. Once the user provided all the necessary inputs, the method may include, according to some embodiments of the invention, for example, generating a coverage areas schematically indicated by box 250. A coverage area may be associated with its corresponding sensor. In the event a plurality of coverage areas are schematically displayed associated with corresponding sensors, each coverage area may be distinguished by different corresponding distinct graphical means such as, for example, different colors, different hatching types and the like.

According to some embodiments of the invention, the CASD system 100 enables projecting a coverage area onto an image of the real terrain. Such images can be of various types and of different sources, including but not limited to, aerial photo images, orthophoto images, satellite photo images and the like.

According to some embodiments of the invention, the CASD system 100 enables the user to change any the parameters pertaining to the design of a scenario heuristically, in order to achieve his/her targets and/or meet specified constraints using e.g., SVM module 166. The SVM module 166 may enable generating a 3D view of the area through the selected sensors, thereby allowing an illustration of the actual recommended alternative. Furthermore, the recommended alternatives can be exclusively inspected using a virtual 3D environment. As indicated by box 280, a simulation can be completed at any stage.

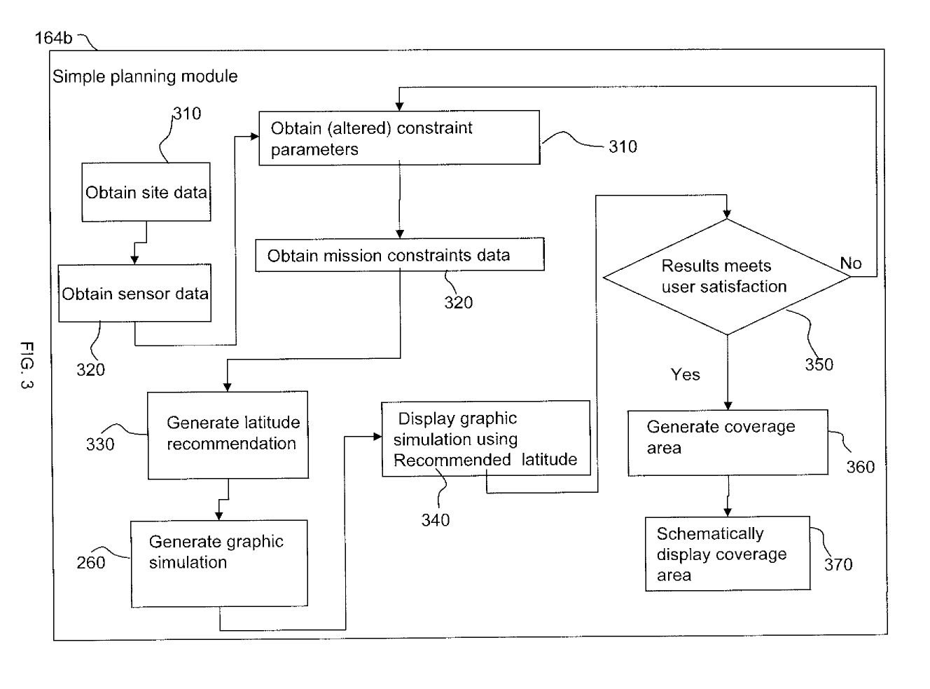

Reference is now made to FIG. 3. An SPM 164b may execute a sensor planning method that may include, for example, the step of obtaining site data 310, obtaining sensor data, determining a coverage area and schematically displaying a coverage area. The CASD system 100 may obtain from the user inputs that pertain to scenario specification such as, for example, terrain coordinates, point-of-view coordinates of the terrain, coordinates of a target area and/or points, coordinates of a friendly area, sensor parameters and the like, as indicated by box 310 using e.g., the SVM graphic simulator 166 or any other suitable input interface. SVM simulator 166 may provide the user, inter alia, with a schematic 3D virtual reality graphical representation of the terrain.

According to some embodiments of the invention, the method of planning the position of at least one sensor in the theater may include the step of obtaining mission constraints data, as indicated by box 320. The CASD system 100 may obtain the constraints data that have to be met for a specific scenario from the user via a suitable input device (not shown). Such constraints data may represent, for example, minimum required coverage of a target area (e.g., in percentage), maximum feasible latitude, weighing factors for each target point and/or target area and/or section within a target area, wherein the weighing factors may correspond to the relative importance pertaining to surveillance requirements, and the like.

The method may further include, for example, the step of providing the user with at least one alternative of position of the at least one sensor, as indicated by box 330. According to an embodiment of the invention, the method may include the step of determining the area covered by each sensor, as indicated by box 360.

According to an embodiment of the invention, the method may include the step of graphically representing the area covered by each sensor, as schematically indicated by box 370.

According to some embodiments of the invention, the method may include the step of providing the user with a graphical representation of the real theater from the viewpoint of the sensor(s) 340. The recommended alternatives can be schematically illustrated by utilizing a suitable 3D virtual reality, illustrating the actual sensor's view point. According to some embodiments of the invention, if any of the constraints specified by the user could not be met, as indicated by the block 350, the method may include the step of altering parameters such as, e.g., target area and the like.

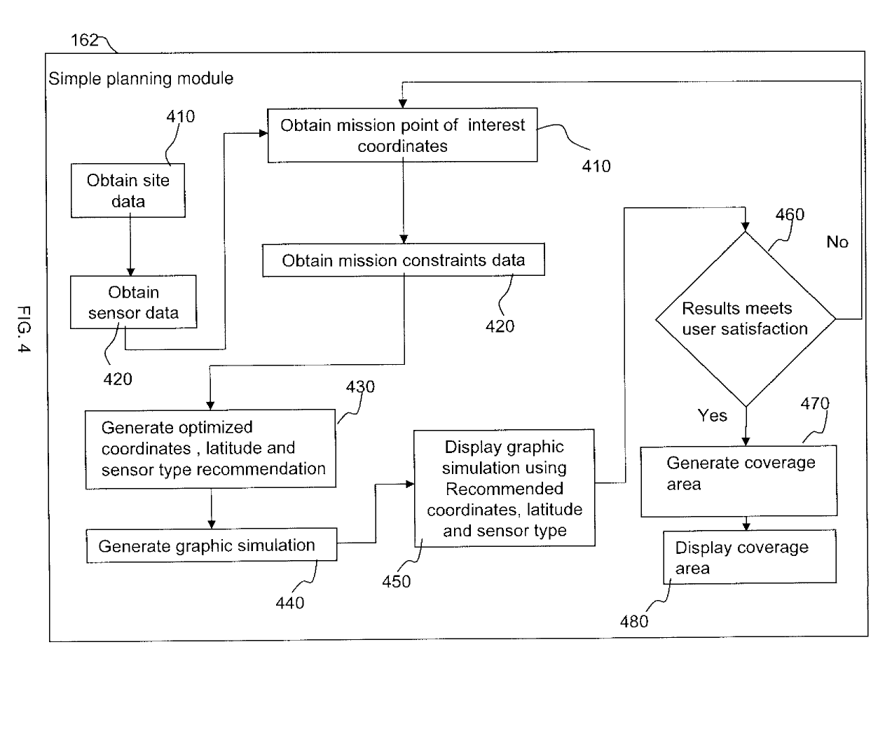

Reference is now made to FIG. 4. The APM module 162 may execute of a sensor planning method that may include, for example, the step of simulating a scenario of a coverage area of at least one sensor positioned in the real theater by means of, e.g., the modeled theater.

The simulated scenario may schematically illustrate multiple view points of said sensor(s) accompanied by recommendations of respective sensor positions. A simulated scenario may include actual map coordinates, which may be associated with relative world latitude and world longitude. Consequently, an optimized solution can be generated, based on user constraints. User constraints span a wide variety of operational categories, constituting the desired specific solution, and can be one or more of the following options:

The area to be observed or the percentage of that area.

Specific points of interest which have to be observed

Specific points of view or maximum latitude.

The area from which operation is possible

Required correlation between devices

Constraints derived from infrastructure such as distance, accessibility, power supply, communication etc.

Land condition and ownerships

Interoperable demands between sensors.

Overall costs: devices, site modification, infrastructure and human factors.

Furthermore, a mission time scope can be selected. A short time scope determines a more dynamic mission nature and fast optimization solutions, while a long run scope determines a more static mission nature, and an unlimited optimization time. A good example for a short time scope mission could be served, when imagining a force task moving into a mission territory. In order to optimize force's control over mission territory, a maximum coverage area of said territory must be obtained. Moreover, the nature of such missions, forces optimization process to supply the scenario simulation in a short time. A long time scope example could be served by the traditional guard tower. The CASD system 100 may recommend the position and/or height of multiple towers, based on mission constraints. Similarly to methods described above, the process starts with obtaining site 210 and sensor 220 data.

The user may then be asked to specify the details regarding the scenario simulated. At this point the user should specify the points of interest coordinates 410 using the SVM module 166, along with other said mission constraints 420. Once all mission constraints have been assigned, one or more optimized solutions are generated 430, accompanied by a graphic simulation 440, thereby enabling the user to explore said area using recommended view points and associated sensors 450. The CASD system 100 may enable the user to select the desired solution if multiple results were generated and change any of the mission constraints heuristically, in order to achieve his targets 460. Each of the recommended solutions can be exclusively inspected using a three-dimensional (3D) simulation, schematically illustrating the actual sensors' view point. If results meet mission requirements, a coverage area is generated 470 and schematically displayed 480 in the same manners earlier described.

The CASD system 100 may be able to provide various types of reports. A report generally comprises system recommendations that may include sensors type and position. These reports can be generated in an HTML file format, an Extensible Markup Language (XML) format, spreadsheet file format, a word processing format, a CAD report, in an image format or in any other suitable format.

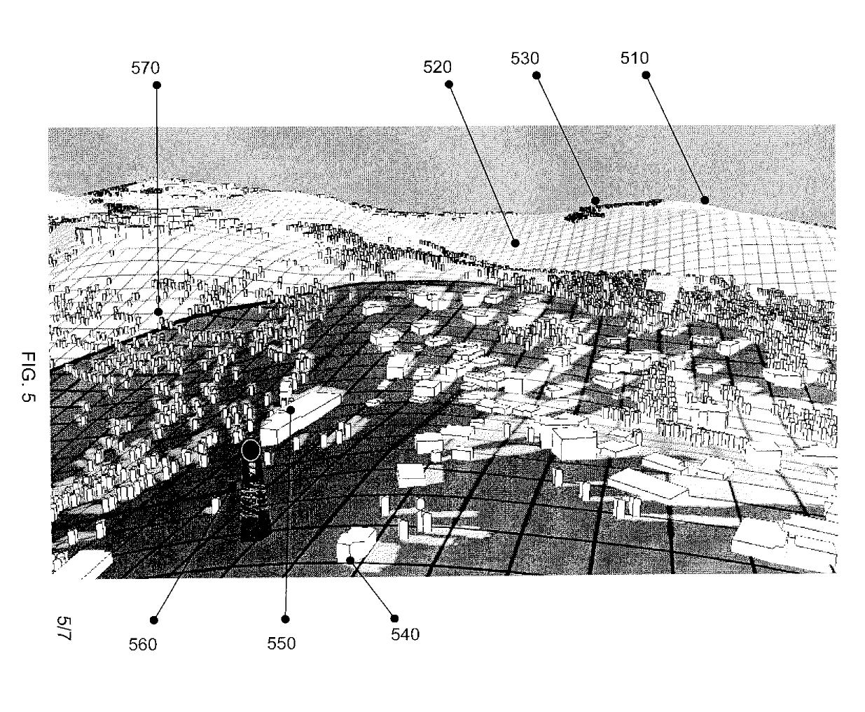

Reference is now made to FIG. 5. As already mentioned above, simulation may start with obtaining site data and sensor data. Site data may represent different types of landscape properties and/or construction entities and the like. Landscape properties can be of various types, such as, for example, hills 510, a valley 520 or trees 530. Construction entities describe all existing buildings within the area 540 and any construction planned to be built in the future 550. Once scenario constraints are entered, an optimized security solution is generated and multiple sensors of different types are positioned 560 at the area. For each of the positioned sensors, their corresponding coverage area is schematically indicated 570 by means of distinctive visual indications such as different colors, cross-hatching and the like to enable distinction between covered and uncovered areas 580.

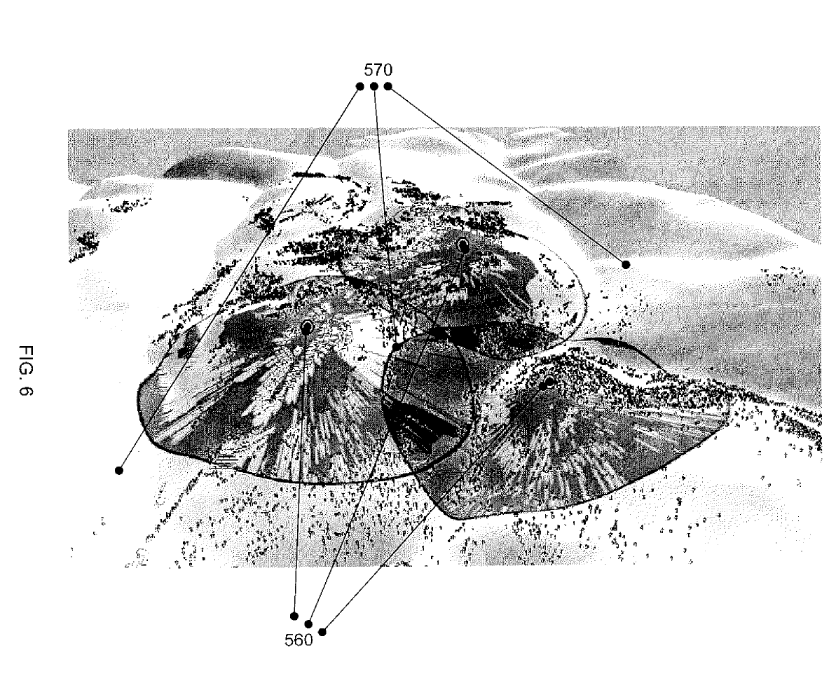

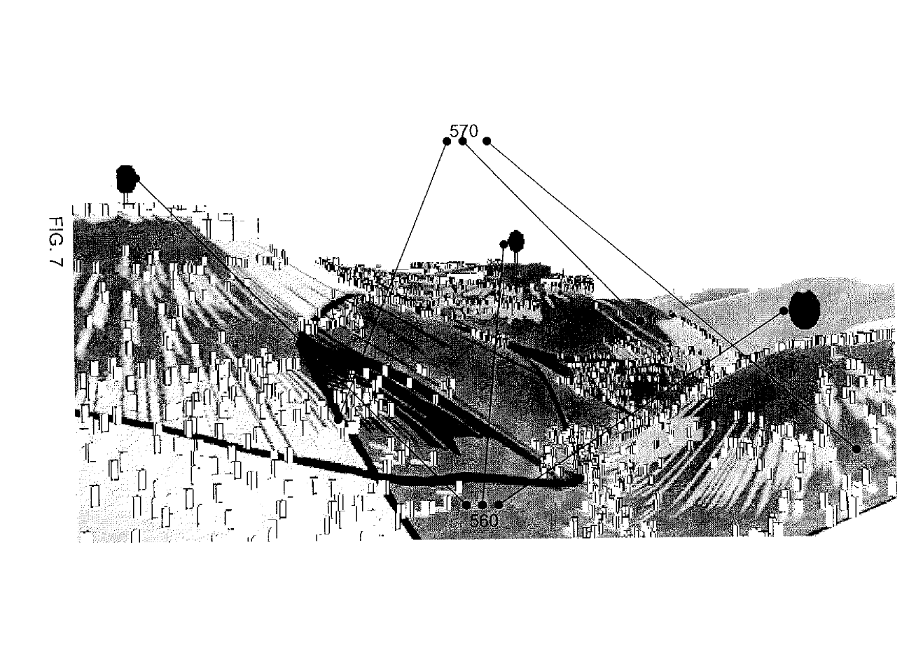

Reference is now made to FIG. 6 and to FIG. 7. Once all sensors are positioned 560, corresponding coverage areas may be schematically displayed. Each coverage area may be painted with different colors, thereby allowing a clear distinction between covered and uncovered areas. The CASD system 100 may enable viewing the sensors 560 and the corresponding coverage area 570 from various angles, thereby improving simulation control and supplying an advanced decision support framework.

According to some embodiments of the invention, various engineering tools supporting the design process are provided. Such tools may enable, inter alia, measuring the shortest distance between two nodes schematically indicated in the modeled theater; measuring the distance between two nodes whilst taking into account the topography between said two nodes; measuring and/or indicating the progression of a particular moving object as a function of time; analyze various paths of progression of a particular moving object for optimization; schematically displaying some of the modeled theater in various visibility conditions; and the like.

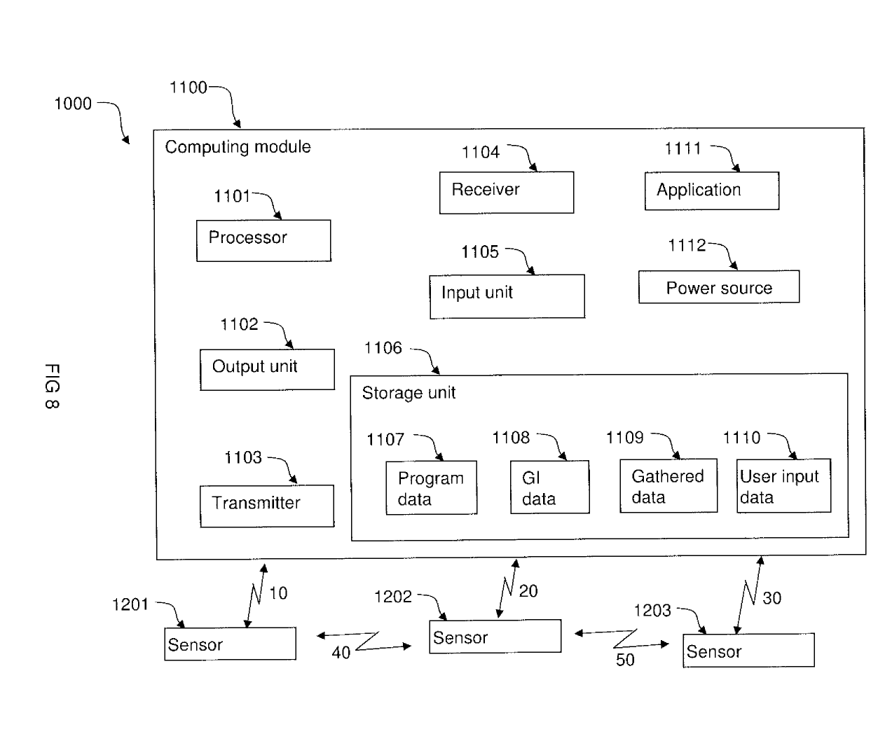

Reference is now made to FIG. 8. According to some embodiments of the invention, a CASD system such as, for example, CASD system 1000, may include a computing module 1100. The computing module 1100 may include a processor 1101, an output unit 1102, a transmitter 1103, a receiver 1104, an input unit 1105, and a storage unit 1106, all of which may be associated with a suitable power source 1112.

The computing module 1100 may include, without limitations, a cellular telephone, a wireless telephone, a Personal Communication Systems (PCS) device, a PDA device that incorporates a wireless communication device, a tablet computer, a server computer, a personal computers, a wireless communication station, a mobile computer, a notebook computer, a desktop computer, a laptop computer a Personal Digital Assistant (PDA) device and the like.

Processor 1101 may be a chip, a microprocessor, a controller, a Central Processing Unit (CPU), a Digital Signal Processor (DSP), a microchip, an Integrated Circuit (IC), or any other suitable multi-purpose or specific processor or controller.

The output unit 1102 may be a liquid crystal display (LCD), a cathode ray tube (CRT) monitor, or any other suitable output unit.

The transmitter 1103 may be any suitable transmission device.

The receiver 1104 may be, for example, a heterodyne receiver, or any other suitable receiver device.

The input unit 1105 may be a keyboard, a touch pad, a touch screen, a mouse, a tracking device, a pointing device, or any other suitable input device.

The storage unit 1106 may be a hard disk drive, a floppy disk drive, a Compact Disk (CD) drive, a CD-ROM drive, a digital versatile disc (DVD) drive, or other suitable removable or non-removable storage units. Furthermore, storage unit 1106 may be a Random Access Memory (RAM), a Dynamic RAM (DRAM), a Synchronous DRAM (SD-RAM), a Flash memory, a volatile memory, a non-volatile memory, a cache memory, a buffer, a short-term memory unit, a long-term memory unit, or other suitable memory units or storage units

Program data 1107 and/or GI data 1108 and/or gathered data 1109 and/or user input data 1110 may be stored in storage unit 1106 as a standard object-like table.

The power source 1112 may be, for example, a rechargeable battery, a non-rechargeable battery, and the like.

The antenna 12200 may be a micro-strip antenna, an omni-directional antenna, a diversity antenna, a dipole antenna, a monopole antenna, an end-fed-antenna, a circularly polarized antenna, or any other type of antenna suitable for sending and/or receiving wireless signals and/or blocks and/or frames and/or transmission streams and/or packets and/or messages and/or data.

According to some embodiments of the invention, storage unit 1106 may store therein data representing program instructions (hereinafter referred to as “program data”) 1107, data representing geographical information (hereinafter referred to as “GI data”) 1108 of a real theater.

According to some embodiments of the invention, the GI data 1108 may represent information about the topography of a terrain of a real theater, information of world-coordinates of objects located in the theater (e.g., an object's latitude, longitude and height above sea level), a country border, vegetation (e.g., trees and types of trees), mountains, rivers, rocks, soil structure, and the like; manmade objects in the real theater such as, for example, streets, roads, houses, buildings, fences, walls, towers, electrical power lines, pipelines, and the like.

Moreover, GI data 1108 may, inter alia, represent information pertaining to the function and/or other attributes of at least some of the real theater's objects such as, for example, the presence of a school; a shopping mall; a sports arena; a military base; a residential building; a military installation; a training camp; an airport; a train station; a bus station; a gas station; a water pipeline; an oil pipeline; the approximate number of residents living in a specific residential building; approximate number of residents of a specific apartment; average number of people being present at a specific time in a school; number and/or types and/or location of vehicles in a military installation; location and/or functional parameters of weaponry in a military installation; frequency of a patrol; number of personnel per patrol; and the like.

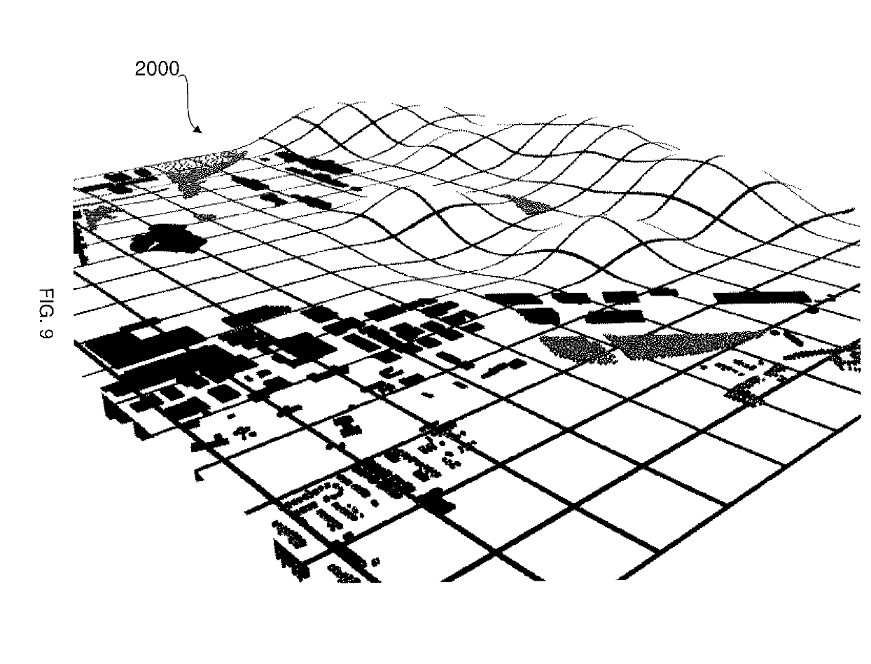

Further reference is now made to FIG. 9. According to some embodiments of the invention, the processor 1101 may execute the program data 1107 resulting in an application 1111 that, inter alia, may fetch at least some of the GI data 1108 and model thereof a model of a theater (hereinafter referred to as “modeled theater”) 2000 on the output unit 1102. In accordance to the real theater, the modeled theater 2000 may comprise and schematically display virtual objects via the output unit 1102 and may comprise, inter alia, of a modeled terrain.

Optionally, application 1111 may fetch some of the GI data 1108 for displaying one or more suitable annotations indicating attributes and/or functions of corresponding virtual objects on the output unit 1102. For example, a block representing a military base schematically displayed on the output unit 1102 may be annotated with the term “military base”.

Optionally, application 1111 may model said virtual objects in a manner inherently indicating their functionality. For example, the application 1111 may model a virtual object substantially having the shape of an airplane to symbolize the location of an airport in the real theater by means of the modeled theater 2000.

According to some embodiments of the invention, the storage unit 1106 may store data representing physical stimuli (hereinafter referred to as “gathered data”) 1109 detected by sensors located in the real theater. The gathered data 1109 may represent, for example, data pertaining to environmental conditions (e.g., temperature, wind velocity, humidity, pressure, visibility conditions, rain, fog, snow, current brightness), and the like; data pertaining to security issues such as intrusion detection.

According to some embodiments of the invention, the gathered data 1109 may be sent from a sensor (not shown) stationed in the real theater to the computing module 1100 substantially in real time via a suitable communication link. For example, data may be sent from the real sensor 1201 to the computing module 1100 via communication link 10. In some aspects of the invention, data may be sent from a one sensor to the computing module 1100 via another sensor and/or server or suitable computing module. For example, data may be sent from the sensor 1201 to the sensor 1202 via communication link 40, and from the sensor 1202 to the computing module 1100 via the communication link 20. Other data transmission schemes may be possible.

According to some embodiments of the invention, the gathered data 1109 may be sent from a real sensor such as, e.g., sensor 1201, to a workstation of a control room.

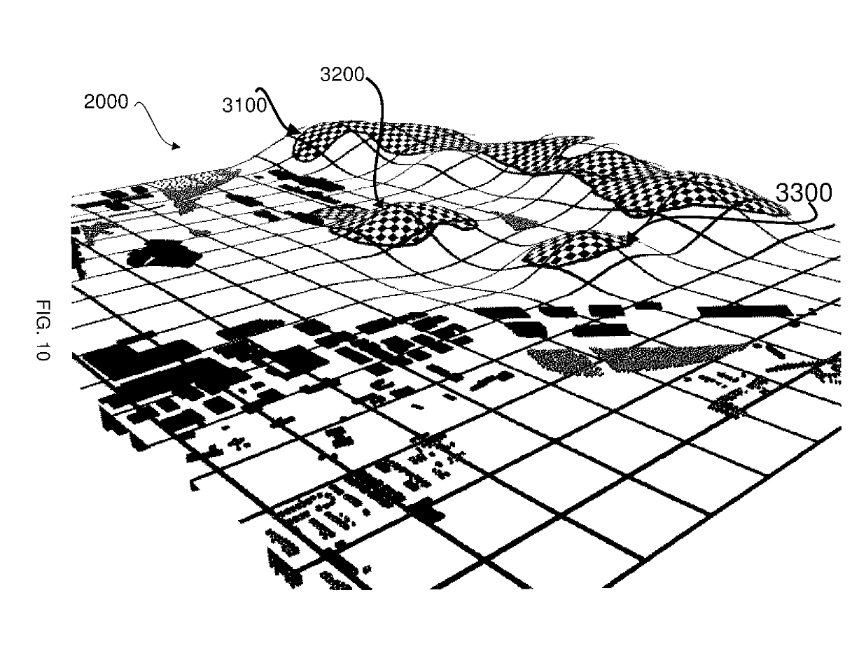

Additional reference is now made to FIG. 10. According to some embodiments of the invention, GI data 1108 may include data (hereinafter referred to as “allowed-site data”) representing information about at least one allowed-site of the real theater. An allowed-site as specified herein, is a site in which the positioning of a sensor may be allowed. An allowed-site in the real theater may pertain to, for example, a closed region, a specific object, a borderline, and the like, which may be schematically indicated on output unit 1102 by a closed line; a point; and an open line respectively. A line may be schematically illustrated by at least one curved line and/or by at least one straight line.

According to some embodiments of the invention, the application 1111 may fetch the allowed-site data and may schematically display in the modeled theater 2000 said at least one allowed-site as, for example, the virtual allowed-site 3100, the virtual allowed-site 3200 and the virtual allowed-site 3300.

According to some embodiments of the invention, the allowed-site data is provided by the user of system 1000 via, e.g., the input unit 1105. For example, the user may indicate the location or boundary of an allowed-site by providing a suitable input via input unit 1105, wherein said input may generate, for example, the virtual allowed-site 3100.

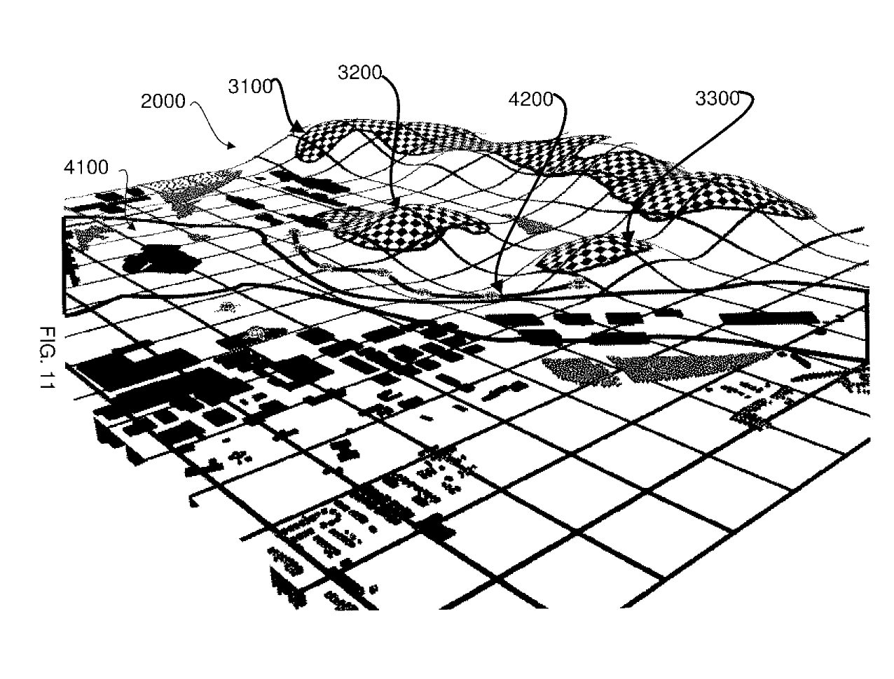

Additional reference is now made to FIG. 11. According to some embodiments of the invention, the GI data 1108 may include data representing information about at least one threat-site of the real theater. Such data is hereinafter referred to as “threat-site data”. In distinct contrast to an allowed-site, a threat-site is a site in which the positioning of a sensor is not allowed. Similar to an allowed-site, a threat-site may pertain to, for example, a closed region in the real theater, a specific object in the theater, a borderline in the real theater, and the like.

According to some embodiments of the invention, application 1111 may fetch the threat-site data and may schematically display in modeled theater 2000 said at least one threat-site by means of, for example, virtual threat-site 4100 and virtual threat-site 4200.

A threat-site in the real theater may pertain to, for example, a closed region, a specific object, a borderline, and the like, which may schematically indicated on output unit 1102 by a closed line; a point; and an open line respectively. As already mentioned above, a line may be composed schematically by at least one curved line and/or by at least one straight line.

The virtual threat-site 4100 may be schematically bounded by curved and/or by straight lines, whilst the virtual threat-site 4200 schematically outlines a line, which may be composed of straight and/or curved line segments.

According to some embodiments of the invention, the threat-site data is provided by the user of the CASD system 1000 via, e.g., the input unit 1105. For example, the user may use the input unit to provide data representing the threat-site, which may be schematically illustrated by means of a virtual threat-site such as virtual threat site 4100.

According to some embodiments of the invention, storage unit 1106 may store therein user input data 1110 representing information about other parameter constraints, some of which may be provided to storage unit 1106 by the user.

Such a parameter constraint may be, inter alia, a weighing factor that the user may assign to a certain threat-site and/or section within a threat-site, wherein such a weighing factor indicates the importance of the threat-site and/or section therein with regard to surveillance requirements. For example, the CASD system 1000 may enable the user to define weighing factors 1, 2, 3, 4 and 5 for each threat-site in the real theater by means of corresponding virtual threat-sites, wherein the value 1 of such a weighing factor may indicate that a threat-site associated thereto does not necessarily have to be covered by a sensor. Conversely, the value 5 of a weighing factor might indicate that a threat-site associated thereto has to be covered by at least one sensor.

Additional constraints may include, for example, minimum required coverage of a real threat-site (indicated e.g., in percentage), sensor data such as sensor type (e.g., radar, image sensor, optical sensor, acoustic sensor, chemicals sensors, radiological sensors, biological sensors, Geiger counter sensors, thermal sensors and the like), other operational parameters (e.g., pitch, roil, yaw, zoom range, dynamic range, operating temperatures, weighing factor,), financial constraints (e.g., cost of a sensor, budget), availability of the real sensor (e.g., time of delivery), availability of a mast that is adapted to mount thereon a sensor, the height of each available mast, interoperable demands between sensors, minimum overlap of area of coverage of two sensors, and the like.

According to some embodiments of the invention, the application 1111 may determine a scenario, which may represent a first alternative of a position of at least one sensor in at least one allowed-site and the corresponding coverage area of the at least one sensor, wherein the first alternative may represent, for example, optimized coverage of at least one threat site by at least one sensor (not shown). According to some embodiments of the invention, such a scenario may be determined according to parameter constraints which may be defined by the GI data 1108 and/or the gathered data 1109 and/or the user input data 1110. Furthermore, according to some embodiments of the invention, the scenarios determined by the application 1111 may be presented to the user in accordance to their operational efficiency. For example, the scenarios may be presented in an order that corresponds to a decreasing threat-site coverage by the at least one sensor.

According to some embodiments of the invention, determining such a scenario may be accomplished by performing, for example, computational analysis that may include the testing of the effect of each constraint on the monitoring capabilities such as, e.g., amount of coverage of a threat area, provided by the at least one sensor. Computational analysis may include instantiating suitable parameters stored in CASD system 1000 and/or image analysis (e.g., counting of pixels), and/or image processing and/or geometrical analysis.

According to some embodiments of the invention, at least two distinct weighing factors may be assigned to corresponding parameter constraints, such that the weighted parameter constraints may be taken differently into consideration by the application 1111. For example, in some embodiments of the invention, the constraint representing a weighing factor of a threat-site may be considered by the application 1111 prior to all other constraints, i.e., a scenario is determined by the application 1111 in a manner such that the constraint representing a weighing factor of a threat-site is met first.

According to some embodiments of the invention, the order according to which some constraints are to be taken into consideration by the application 1111 for determining a scenario is predefined in the CASD system 1000.

According to some embodiments of the invention, the order according to which some of the constraints are to be taken into consideration by the application 1111 for determining a scenario may be defined by the user of the CASD system 1000. For example, the user of the CASD system 1000 may determine that the constraints representing weighing factor of a threat-site, minimal required coverage of a threat-site by a sensor, and maximal costs for execution a scenario cost may be ordered according to decreasing preference, i.e., first the condition of the constraint representing the weighing factor of a threat-site must be met, then the condition of minimal required coverage and only then the condition maximal cost.

According to some embodiments of the invention, to indicate the order or preference according to which the application 1111 should determine a specific scenario; the user may associate to at least some of the constraints a specific weighing factor, hierarchically order at least some of the constraints, and the like.

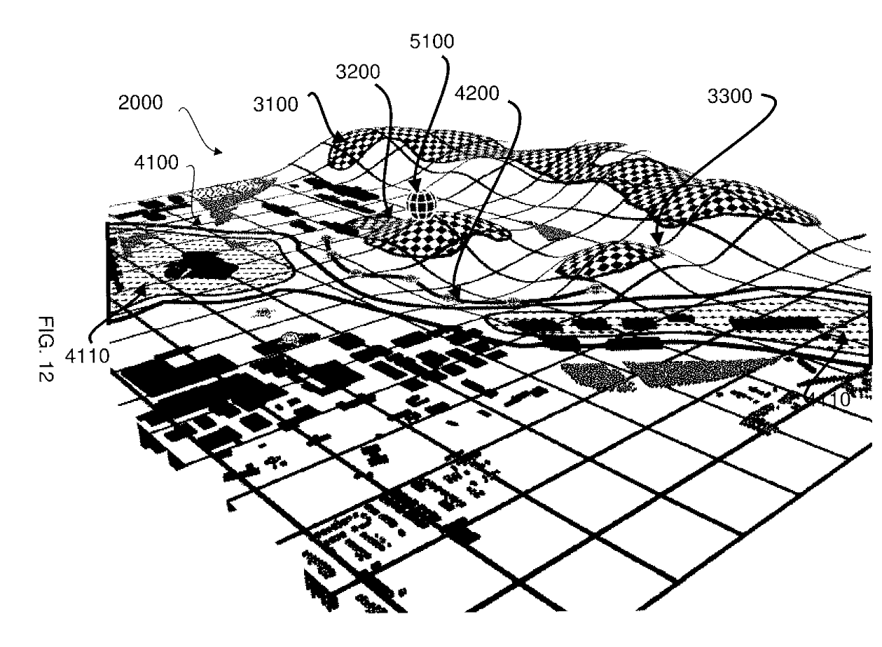

Additional reference is now made to FIG. 12. The application 1111 may determine a first scenario representing the position of a first sensor (not shown) in the real terrain. The first scenario may be schematically illustrated on output unit 1102 by means of a first virtual sensor 5100 in the virtual allowed-site 3200. The coverage area of the first sensor may be schematically illustrated by means of the virtual area-of-coverage 4110. As exemplified in FIG. 12, one of the constraints taken into consideration by application 1111 may represent a condition requiring that first virtual sensor 5100 is to be positioned within the virtual allowed-site 3200.

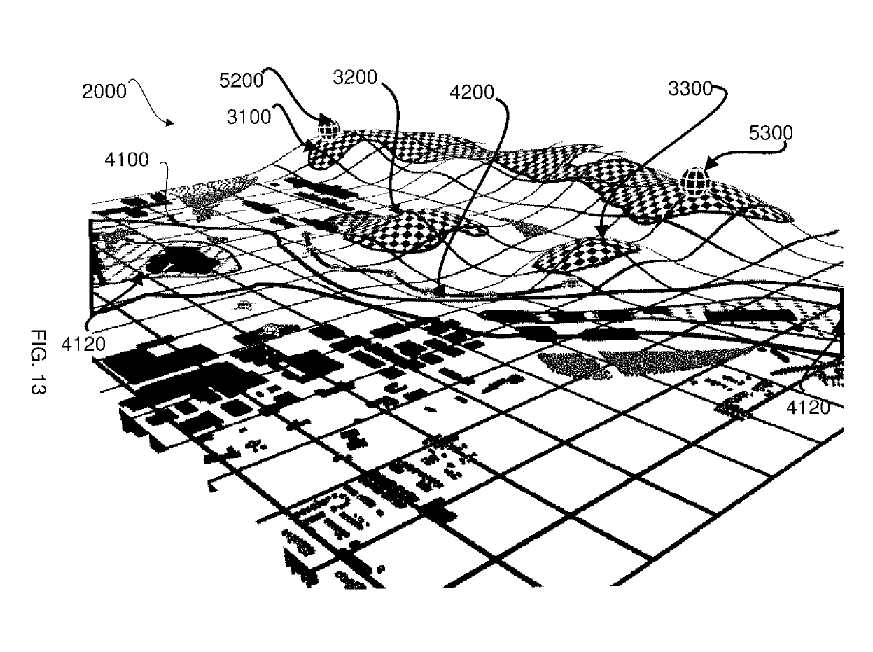

Additional reference is now made to FIG. 13. In embodiments of the invention, the application 1111 may determine a second scenario, which may be determined by application 1111 and optionally schematically illustrated on output unit 1102. The second scenario may represent the position of a second sensor (not shown) and a third sensor (not shown) in the real terrain by means of a second virtual sensor 5200 and a third virtual sensor 5300 on output unit 1102. The respective areas-of-coverage of the second and third sensor in the real terrain may be schematically illustrated on output unit 1102 by means of virtual areas-of-coverage 4110 and 4120 of respective virtual sensors 5200 and 5300. As exemplified in FIG. 13, one of the constraints taken into consideration by the application 1111 may represent a condition requiring that both the second virtual sensor 5200 and the third virtual sensor 5300 are to be positioned within the virtual allowed-site 3100.

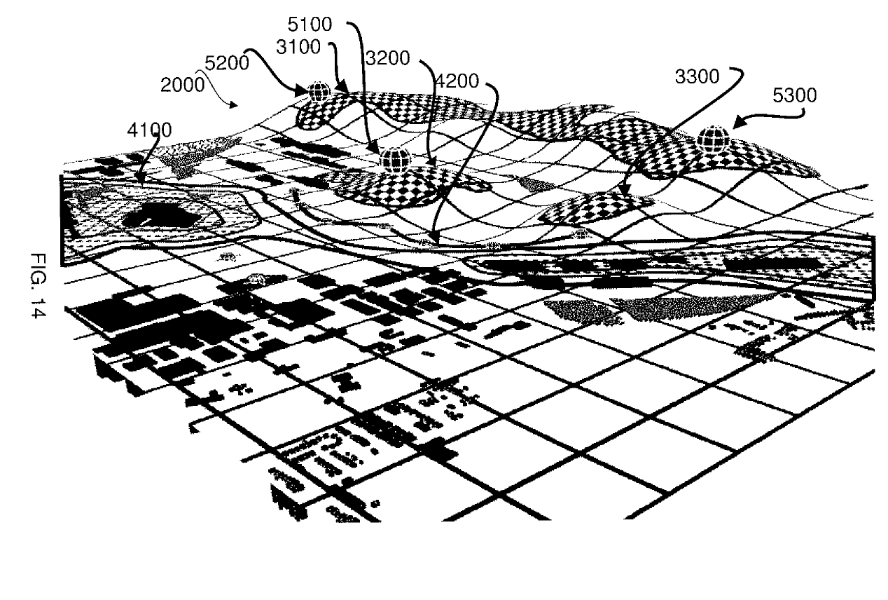

Further reference is now made to FIG. 14. For example, the application 1111 may determine a third scenario representing the position of the first, second and third sensor in the real terrain and the first, second and third sensors' corresponding area-of-coverage by means of the virtual sensor 5100, virtual sensor 5200 and virtual sensor 5300 and the virtual areas-of-coverage 4210 and 4220. As exemplified in FIG. 14, one of the constraints taken into consideration by the application 1111 may represent a condition which requires that the first virtual sensor 5100 is positioned within the virtual allowed-site 3200 and that the second 5200 and the third virtual sensor 5300 are both positioned within the virtual allowed-site 3100. The application 1111 may further model the third scenario that is then schematically illustrated on the output unit 1102.

As can readily be seen from the comparison of the virtual area-of-coverage 4110 against the area-of-coverage 4120, the virtual area-of-coverage 4110 is substantially larger than the virtual area-of-coverage 4120. Accordingly, the user may prefer to use the sensor at the positioned that is represented by virtual sensor 5100 for monitoring the threat-site represented by virtual threat-site 4100.

As can readily be seen in FIG. 12, FIG. 13 and FIG. 14, the application 1111 enables simulating and schematically illustrating via the output unit 1102 a plurality of alternative positions for one or more sensors in the real theater by means of virtual sensors, such as, for example, virtual sensors 5100, 5200 and 5300 that are schematically illustrated in the modeled theater 2000.

According to some embodiments of the invention, every area that is schematically displayed on the output unit 1102 such as, e.g., a virtual threat-site, a virtual allowed-site, a virtual area-of-coverage and the like, may be schematically marked by suitable cross-hatching and/or coloring and the like.

In some embodiments of the invention, the user may select a scenario out of a plurality of scenarios.

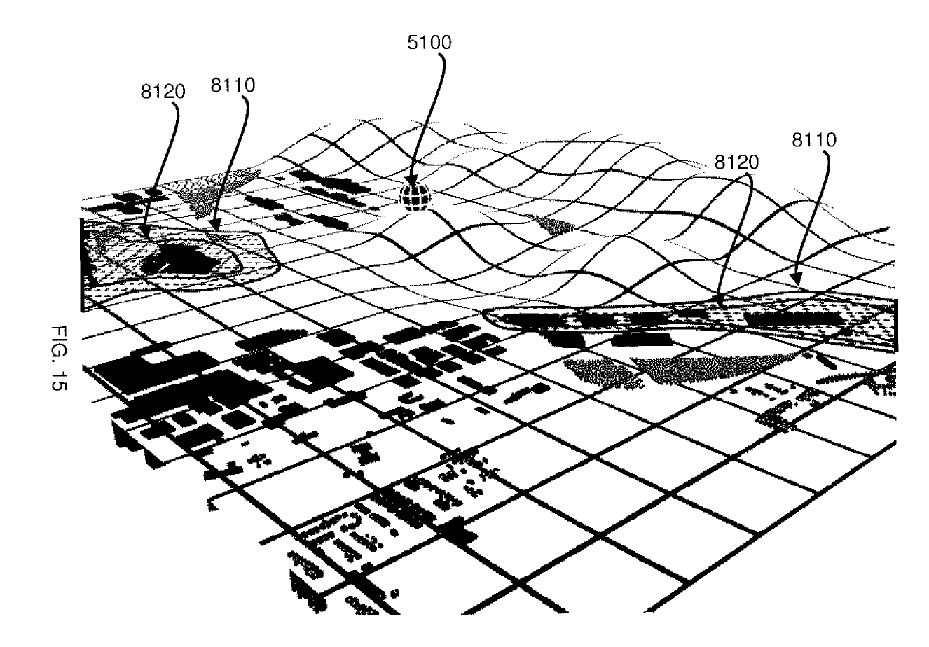

Reference is now made to FIG. 15. Environmental conditions may have a significant impact on the area of coverage that may be provided by a sensor positioned in the real theater. For example, visibility of an optical sensor located in the real theater may be impaired during rainfall in contrast to the visibility when no rainfall is present. Correspondingly, the area of coverage that may be provided by said optical sensor may be impaired during rainfall compared to the area of coverage that may be obtained when no rainfall is present.

According to some embodiments of the invention, the CASD system 1000 enables the simulation of various environmental conditions that may prevail in the real theater and determine the corresponding area of coverage. For example, the virtual area-of-coverage 8110 may schematically illustrate the corresponding area of coverage of a sensor represented by the virtual sensor 5100, when the environmental conditions provide ideal visibility, whilst the virtual area-of-coverage 8120 may represent the area coverage by the sensor represented by virtual sensor 5100, when the visibility conditions are substantially impaired due to, e.g., rainfall, fog, snowfall, hail, smog, darkness and the like.

It should be understood that the term “visibility” as used herein may not necessarily refer to optical spectrum, but may also refer to other spectra such as, for example, radio frequency spectra that may be used by radar sensors. Operational sensing range of a radar sensor may be impaired due to, for example, rain.

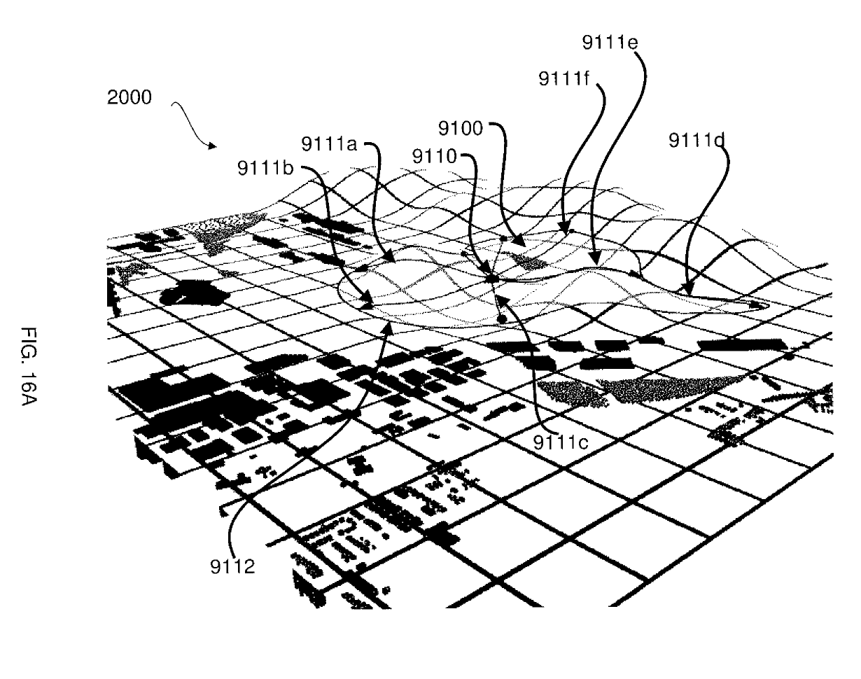

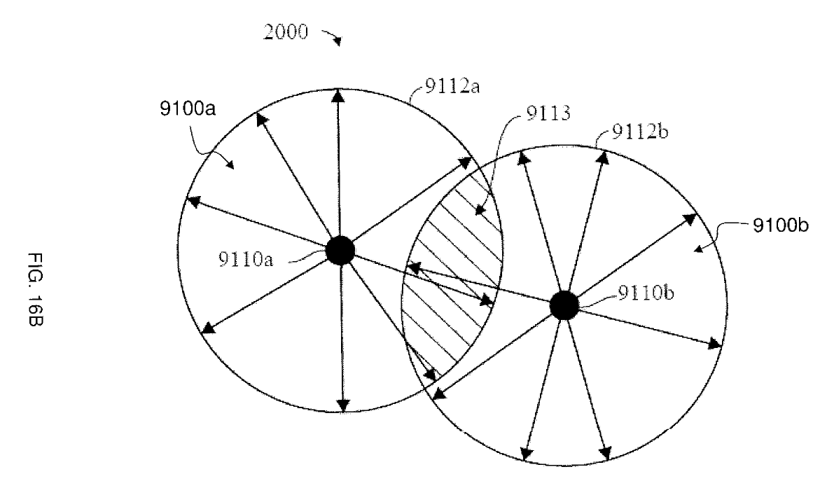

Reference is now made to FIG. 16A. According to some embodiments of the invention, defining in the real theater a threat or allowed-area, which is represented by virtual area 9100, may be accomplished by simulating (with application 1111) the progression of an object along at least one path in the real terrain within a given time interval “t”, by means of a virtual object 9110 in the modeled theater 2000. Various path(s) that the object may pass during the time interval “t”, may be schematically illustrated in the modeled theater 2000 by a plurality of virtual paths 9111a-9111f emanating in various directions from the virtual object 9110. For example, to schematically illustrate the extent of the corresponding virtual threat-site 9100, end points of the successive virtual paths 9111a-9111f may be connected virtually by, e.g., a virtual curve 9112 enclosing an area of possible threat.

In some embodiments, the threat and/or allowed site may be determined according to virtual paths that may emanate radially from a virtual common point, which may represent the starting point of the object.

The progression of a moving object in the real terrain may depend, for example, on the topography of the real terrain, the object's operational parameters (e.g., type of vehicle) and the like. Said dependence may be simulated by the application 1111 as is schematically illustrated on the output unit 1102 by the different lengths of virtual paths 9111a-9111f. For example, virtual path 9111c may simulate a slower progression of moving object 9110 thereon than the progression of moving object 9110 along path 9111d. Such a slower progression in the real terrain may be caused by, e.g., obstacles, steep slope, and the like. Consequently, length of virtual path 9111c may be schematically illustrated as shorter than the length of virtual path 9111d.

Accordingly, application 1111 enables estimating the distance an object may pass in the real terrain during a given time interval, wherein the distance may be a function of the objects direction of movement, the object's operational parameters and the like.

The virtual area 9100 may be interpreted by the user of the CASD system 1000 as a threat-site, for example, if the user interprets the virtual object 9110 as an intruder and that the positioning of sensors in the real terrain must be as such to provide advanced enough warning time enabling the intruded side to undertake the necessary steps for preventing the infliction of damages by said intruder.

On the other hand, the virtual area 9100 may be interpreted by the user of CASD system 1000 as an allowed-site. For example, virtual paths 9111a-9111f may represent the paths that an emergency squad is capable to traverse during a certain time interval, whereby the measurement of said time interval may start when said emergency squad receives notification about enemy movement. Consequently, the application 1111 may enable estimating the location of interception of an enemy by said emergency squad by in the real terrain, as outlined herein with reference to FIG. 16B.

Reference is now made to FIG. 16B. According to some embodiments of the invention, application 1111 may schematically generate a virtual threat-area 9100a and a virtual allowed area 9100b, by simulating and schematically illustrating the progression of a first object (not shown) and second object (not shown) in the real terrain by means of virtual moving objects 9110a and 9110b in the modeled terrain 2000, respectively.

The cross-hatched area 9113 schematically illustrates the area at which the first and the second object may meet, or intercept each other. Accordingly, the CASD system 1000 enables estimating the optimal position of at least one emergency squad for intercepting an enemy.

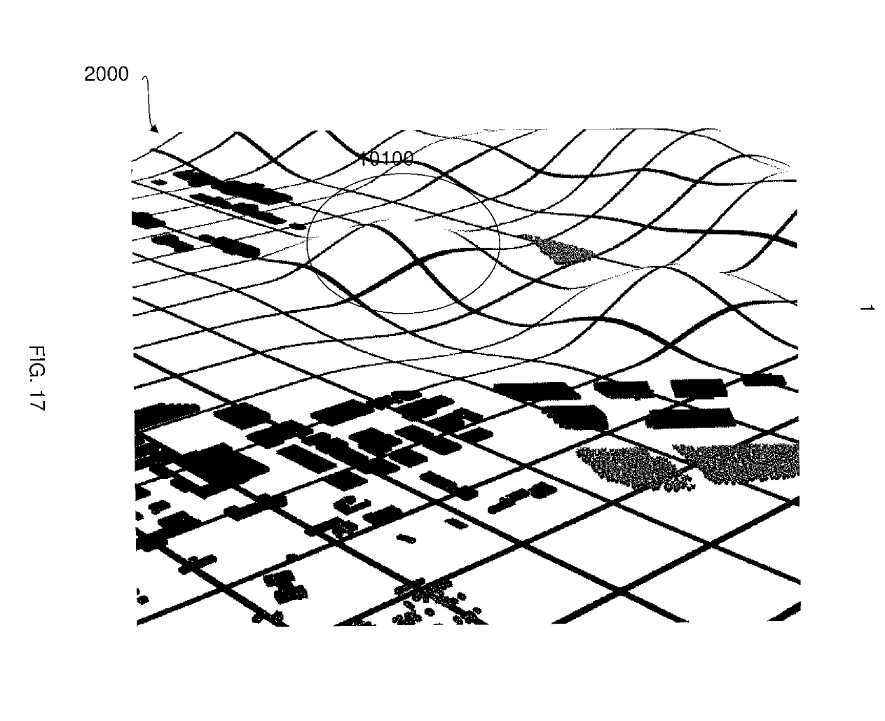

Reference is now made to FIG. 17. According to some embodiments of the invention, a scenario that is modeled by application 1111 and schematically displayed on output unit 1102 may be manipulable (i.e., adjusted and/or modified and/or adapted) by the user via input unit 1105. The user may for example, add, remove and modify virtual objects such as trees, rocks, hills, buildings, barriers, fences, compounds, and the like, that are schematically illustrated in modeled theater 2000 via output unit 1102.

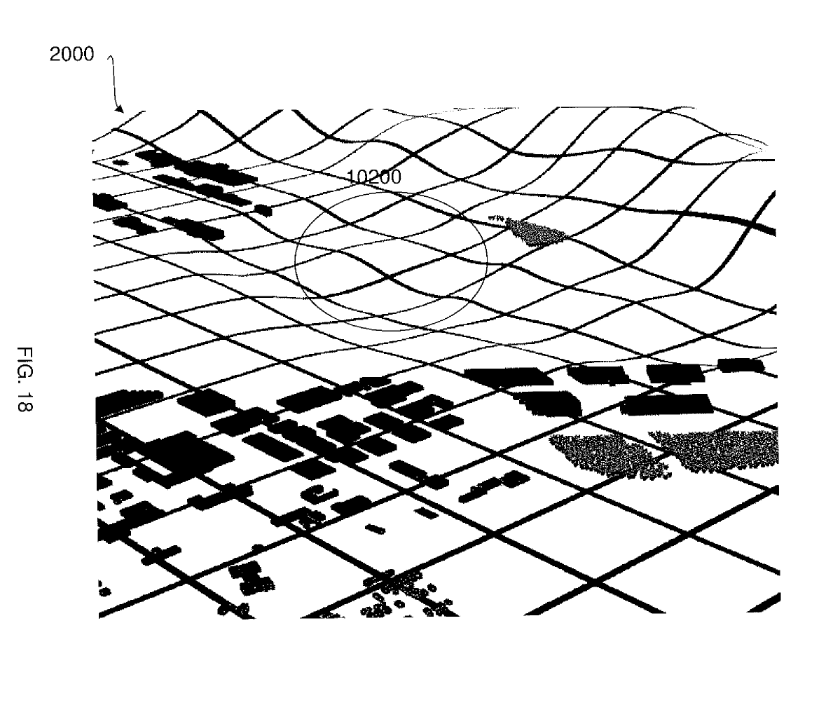

For example, the user may select a hill 10100 that is schematically displayed in the modeled terrain 2000, and may provide an input representing a command for simulating the substantial straightening of the section of the modeled terrain 2000 that has substantially the same coordinates like the hill represented by the virtual hill 10100. The virtually straightened section 10200 of modeled terrain 2000 is schematically illustrated in FIG. 18.

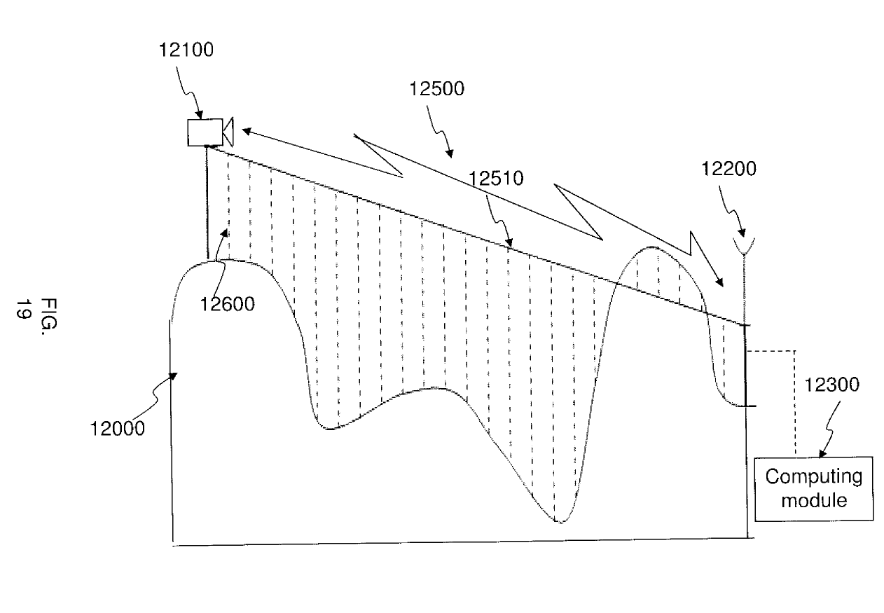

Reference is now made to FIG. 19. According to some embodiments of the invention, application 1111 may be adapted to simulate and/or cause the schematic display of the transmission of data from a sensor (not shown) to a computing unit (not shown) of, e.g., a control room, in the real theater, on the output unit 1102. The computing unit may be located in a suitable war room, bunker, control room and the like and may be linked via a suitable communication channel to said sensor.

The simulation and/or schematic display of data transmission may be accomplished by means of a virtual cross-sectional view of a section 12000 of the modeled theater 2000, wherein said virtual section 12000 may schematically illustrate a virtual sensor 12100, a virtual antenna 12200; a virtual computing module 12300; and a virtual communication link 12500.

According to some embodiments of the invention, the sensor, which is hereinafter represented by virtual sensor 12100, may sense physical stimuli, which may then be converted to sensor data. The sensor may be adapted to send the sensor data to an antenna (not shown) deployed in the real terrain, wherein the antenna is represented by virtual antenna 12200. The sending of the data is accomplished via a communication signal in the real terrain, wherein the channel is represented by virtual signal 12500. However, it has to be ensured that the sensor data can further be processed by the computing unit, which is represented by virtual computing unit 12300. Therefore, application 1111 simulates by means of the virtual sensor 12100 and the virtual antenna 12200 the position of the corresponding sensor and antenna in the real theater, such that the signal received by the antenna has a power level that enables the extraction of the sensor data by the computing unit. As is known in the art, the power level of a signal may change due to attenuation, which may sometimes be referred to as path loss. Attenuation may be caused by many effects, such as, for example, free-space loss, diffraction, refraction, reflection, absorption, coupling loss, and the like. For example, the amount of attenuation of a wireless signal due to the effect of rain may be estimated by the following equation:

A=a*R^{b} (1)

wherein “A” stands for attenuation measured in db/km, “R” for the rain rate (mm/hr), and wherein “a” and “b” are parameters that depend on rain drop size and signal frequency, respectively. It should be understood that other equations may be used for the estimation of wireless signal attenuation due to rain.

The application 1111 of the computing module 1100 may take into consideration various communication parameter constraints that may have an impact on signal-attenuating effects and determine thereof the optimal position for the sensor and the antenna.

In embodiments of the invention, the user may provide the computing module 1100 with input(s) representing such communication parameter constraints via the input unit 1105, whereby said input(s) may be stored in the storage unit 1106 under the user input data 1110. Such input(s) that represent communication parameter constraints may include, for example, distance between the sensor and the antenna, height of the sensor and the antenna above the real terrain, topography of the real terrain between the sensor and the antenna, type of vegetation between the sensor and the antenna, expected and/or current weather conditions in the real theater, air humidity in the real theater, smog in the real theater, and the like. Upon determining the optimal position of the real sensor and the real antenna in the real terrain by taking into consideration the communication parameter constraints, application 1111 may schematically display said optimal position by means of virtual sensor 12100 and virtual sensor 12200 on output unit 1102. Application 1111 may also schematically display the signal attenuation between the sensor and the antenna, which may have a value of, for example, −28 dbm. The application 1111 may further cause the schematic displaying of the line-of-sight (LOS) between the virtual sensor 12100 and the virtual antenna 12200. Furthermore, application 1111 may schematically display signal attenuation between the sensor and the antenna by means of lines 12600 between virtual sensor 12100 and virtual antenna 12200, wherein the interval between two succeeding lines 12600 may indicate a given amount attenuation. For example, the interval two succeeding lines 12600 may represent a signal attenuation of −0.1 dBm, −1 dBm, −2 dBm and the like. Accordingly, the application 1111 may estimate the attenuation for a waveguide or wire medium. A waveguide may include, for example, an optical fiber. A wire medium may include, for example, copper wire.

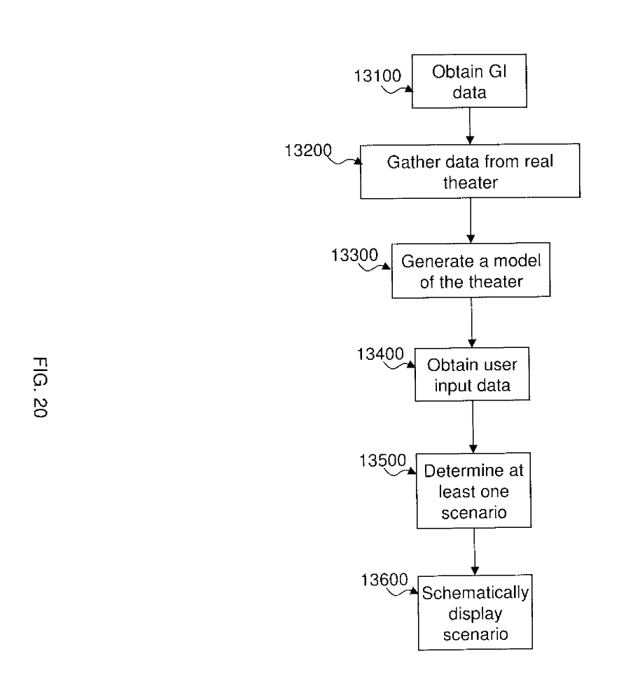

Reference is now made to FIG. 20. According to some embodiments of the invention, as indicated by box 13100, a computer-aided security design method (hereinafter referred to as “method”) may include, for example, the step of obtaining GI data.

According to some embodiments of the invention, as indicated by box 13200, the method may include, for example, the step of gathering data from the real theater.

According to some embodiments of the invention, as indicated by box 13300, the method may include, for example, the step of generating a model of the real theater. For example, modeled theater 2000 may be displayed schematically on the output unit 1102.

According to some embodiments of the invention, as indicated by box 13400, the method may include, for example, the step of obtaining user input data via, e.g., the input unit 1105.

According to some embodiments of the invention, as indicated by box 13500, the method may include, for example, the step of determining at least one scenario by, e.g., the application 1111.

According to some embodiments of the invention, CASD system 1000 enables projecting a coverage area an image of the real theater. Such images can be of various types and of different sources, including but no limited to, aerial photo images, orthophoto images, satellite photo images and the like.

According to some embodiments of the invention, the CASD system 1000 can be interfaced or can be adapted to be interfaced with various external systems such as, for example, a designer program (e.g., Autocad); an external GI system (e.g., a global positioning system); a command, control, communications, computers, and intelligence system (C41); and the like.

According to some embodiments of the invention, the CASD system 1000 enables the user to selectably view a scenario on the output unit 1102 either in a successive or simultaneous manner from various angles, thereby improving simulation control and supplying an advanced decision support framework.

According to some embodiments of the invention, the CASD system 1000 enables to user to record a sequence of frames that are schematically displayed on the output unit 1102.

According to some embodiments of the invention, the CASD system 1000 may provide the user with various engineering tools providing him/her support during the establishment of a scenario. Such tools may include, inter alia, measuring the shortest distance between two nodes that are schematically indicated in the modeled theater 2000; measuring the distance between two nodes whilst taking into account the topography between said two nodes; enabling the selectively choosing of at least one view-point and schematically displaying said at least one viewpoint on output unit 1102; and the like.

According to some embodiments of the invention, the CASD system 1000 enables the issuing of reports, which may include, for example, recommendations regarding of sensors type and position. These reports can be generated, for example, in an HTML file format, in an XML format, in a spreadsheet formal, as a CAD report, in a GI image format or in any other suitable format.

It should be understood that some embodiments of the invention may be implemented, for example, using a machine-readable medium or article which may store an instruction or a set of instructions that, if executed by a machine, cause the machine to perform a method or operations or both in accordance with embodiments of the invention. Such a machine may include, for example, any suitable processing platform, computing platform, computing device, processing device, computing system, processing system, computer, processor, or the like, and may be implemented using any suitable combination of hardware or software or both. The machine-readable medium or article may include but is not limited to, any suitable type of memory unit, memory device, memory article, memory medium, storage article, storage device, storage medium or storage unit such as, for example, memory, removable or non-removable media, erasable or non-erasable media, writeable or re-writeable media, digital or analog media, optical disk, hard disk, floppy disk, Compact Disk Recordable (CD-R), Compact Disk Read Only Memory (CD-ROM), Compact Disk Rewriteable (CD-RW), magnetic media, various types of Digital Versatile Disks (DVDs), a rewritable DVD, a tape, a cassette, or the like. The instructions may include any suitable type of code, for example, an executable code, a compiled code, a dynamic code, a static code, interpreted code, a source code or the like, and may be implemented using any suitable high-level, low-level, object-oriented, visual, compiled or interpreted programming language. Such a compiled or interpreted programming language may be, for example, C, C++, C#, .Net, Java, Pascal, MATLAB, BASIC, Cobol, Fortran, assembly language, machine code and the like.

It should be noted that embodiments of the invention may be used in a variety of applications. Examples of embodiments of the invention may include the usage of the invention in conjunction with many networks. Examples of such networks may include, without limitation, a wide area network (WAN), local area network (LAN), a global communication network, e.g., the Internet, a wireless communication network such as, for example, a wireless LAN (WLAN) communication network, a wireless virtual private network (VPN), a Bluetooth network, a cellular communication network, for example, a 3^{rd} Generation Partnership Project (3GPP), such as, for example, a Global System for Mobile communications (GSM) network, a Code Division Multiple Access (CDMA) communication network, a Wideband CDMA communication network, a Frequency Domain Duplexing (FDD) network, and the like.

While the invention has been described with respect to a limited number of embodiments, these should not be construed as limitations on the scope of the invention, but rather as exemplifications of some of the embodiments. Those skilled in the art will envision other possible variations, modifications, and programs that are also within the scope of the invention. Accordingly, the scope of the invention should not be limited by what has thus far been described, but by the appended claims and their legal equivalents. Therefore, it should be understood that alternatives, modifications, and variations of the present invention are to be construed as being within the scope of the appended claims.

What is claimed is:

1. A computerized method for providing a user with at least one scenario in a modeled theater, said method comprising the steps of:
a) selecting a plurality of threat-sites in said modeled theater, wherein said threat-site comprises at least one of the following: at least one threat-area, and at least one threat object;
b) selecting at least one allowed-site in said modeled theater, wherein said allowed-site is at least one of the following: at least one allowed-area, and at least one allowed-object;
c) providing at least one constraint parameter; and
d) determining said at least one security scenario, the security scenario pertaining to at least one of the following: the position of at least one sensor in the at least one allowed-site;
wherein the determining said at least one scenario is accomplished based on computational analysis of at least one of the following data: geographical information data, gathered data, and user input data; and
wherein said computational analysis includes the testing of the effect of said at least one constraint parameter on the monitoring capabilities of said at least one threat-site by said at least one sensor.

2. The method of claim 1, wherein at least one sensor position provides optimized coverage of said plurality of threat-site.

3. The method of claim 1, comprising the step of schematically illustrating said at least one scenario on an output unit.

4. The method of claim 3, wherein at least one of said scenarios provides optimized coverage of said plurality of threat-sites out of all possible scenarios that are determinable by taking into account said at least one constraint parameter.

5. The method of claim 1, wherein a plurality of scenarios is presented to the user in an order that corresponds to the threat-site coverage provided by said at least one sensor.

6. The method of claim 1, wherein said at least one constraint parameter further indicates at least one of the following:
sensor type; operational parameters of the sensor; sensor availability; visibility of the threat-site depending on environmental conditions; budgetary constraints; communication network parameters; a weighing factor indicating the importance of each threat-site with regard to surveillance requirements, the importance of at least one sector within said at least one threat-site with regard to surveillance requirements; and minimal overlying area covered by two sensors.

7. The method of claim 1, wherein said computational analysis comprises at least one of the following: image analysis and geometrical analysis.

8. The method of claim 1, wherein at least two distinct weighing factors are assigned to at least two corresponding parameter constraints for determining the order according to which said at least two parameter constraints are to be taken into consideration for determining said at least one constraint.

9. The method of claim 1, wherein a threat area is defined by simulating the progression of a real object along at least one path in the real terrain within a certain time interval “t”, by means of a virtual object in the modeled theater.

10. The method of claim 1, wherein said at least one scenario is selectably viewable from various angles in a successive and simultaneous manner.

11. The method of claim 1, further comprising the step of estimating attenuation of a communication signal between said at least one sensor and a receiver of said signal.

12. The method of claim 11, further comprising the step of schematically displaying said attenuation.

13. The method of claim 1, further comprising the step of recording a frame of said at least one scenario and schematically displaying said at least one frame.

14. The method of claim 1, further comprising the step of issuing a report comprising data about said at least one scenario.

15. The method of claim 14, wherein said report is issued in at least one of the following formats: an HTML file format, a spreadsheet formal, and an image format.

16. A computer-aided security design system that enables providing a user with at least one scenario in a modeled theater, said system comprising:
a computing module able to select a plurality of threat-sites in said modeled theater, wherein said threat-site comprises at least one of the following: at least one threat-area, and at least one threat object;
said computing module able to select at least one allowed-site in said modeled theater, wherein said allowed-site is at least one of the following: at least one allowed-area, and at least one allowed-object;
said computing module able to provide at least one constraint parameter; and
said computing module able to determine said at least one security scenario, the security scenario pertaining to at least one of the following: the position of at least one sensor in the at least one allowed-site;
wherein the said computing module determines said at least one scenario according to computational analysis of at least one of the following: geographical information data, gathered data, and user input data;
wherein said computational analysis includes the testing of the effect of said at least one constraint parameter on the monitoring capabilities of said at least one threat-site by said at least one sensor.

17. The system of claim 16, wherein at least one sensor position provides optimized coverage of said plurality of threat-site.

18. The system of claim 16, comprising the step of schematically illustrating said at least one scenario on an output unit.

19. The system of claim 18, wherein said at least one scenario provides optimized coverage of said plurality of threat-sites out of all possible scenarios that are determinable by taking into account said at least one constraint parameter.

20. The system of claim 16, wherein a plurality of scenarios is presented to the user in an order that corresponds to the threat-site coverage provided by said at least one sensor.

21. The system of claim 16, wherein said at least one constraint parameter further indicates at least one of the following:
sensor type; operational parameters of the sensor; sensor availability; visibility of the threat-site depending on environmental conditions; budgetary constraints; communication network parameters; a weighing factor indicating the importance of each threat-site with regard to surveillance requirements, the importance of at least one sector within said at least one threat-site with regard to surveillance requirements; and minimal overlying area covered by two sensors.

22. The system of claim 16, wherein said computational analysis comprises at least one of the following: image analysis and geometrical analysis.

23. The system of claim 16, wherein at least two distinct weighing factors are assigned to at least two corresponding parameter constraints for determining the order according to which said at least two parameter constraints are to be taken into consideration for determining said at least one constraint.

24. The system of claim 16, wherein a threat area is determined by simulating the progression of a real object along at least one path in the real terrain within a certain time interval “t”, by means of a virtual object in the modeled theater.

25. The system of claim 16, wherein said at least one scenario is selectably viewable from various angles in a successive and simultaneous manner.

26. The system of claim 16, wherein said computing module estimates the attenuation of a communication signal between said at least one sensor and a receiver of said signal.

27. The system of claim 26, wherein said computing module schematically displays said attenuation.

28. The system of claim 16, wherein said computing module records a frame of said at least one scenario.

29. The system of claim 16, wherein said computing module issues a report comprising data about said at least one scenario.

30. The system of claim 29, wherein said report is issued in at least one of the following formats: an HTML file format, a spreadsheet formal, and an image format.

31. A system comprising a machine-readable medium embodying therein a computer program enabling the execution of a method by said system, the method comprising the following steps:
a) selecting a plurality of threat-sites in said modeled theater, wherein said threat-site comprises at least one of the following: at least one threat-area, and at least one threat-object;
b) selecting at least one allowed-site in said modeled theater, wherein said allowed-site is at least one of the following: at least one allowed-area, and at least one allowed-object;
c) providing at least one constraint parameter; and
d) determining said at least one security scenario, the security scenario pertaining to at least one of the following: the position of at least one sensor in the at least one allowed-site;
wherein said determining of said at least one scenario is accomplished according to computational analysis of at least one of the following: geographical information data, gathered data, and user input data; and
wherein said computational analysis includes the testing of the effect of said at least one constraint parameter on the monitoring capabilities of said at least one threat-site by said at least one sensor.
